(19) United States
(12) Patent Application Publication
(10) Pub. No.: US 2010/0076979 A1
(43) Pub. Date: Mar. 25, 2010

(54) PERFORMING SEARCH QUERY DIMENSIONAL ANALYSIS ON HETEROGENEOUS STRUCTURED DATA BASED ON RELATIVE DENSITY

(76) Inventors: Xuejun Wang, San Jose, CA (US); Ryan Edmund Sue, Fremont, CA (US); Mike Guangyu Cao, San Jose, CA (US); Lucas Marshall, Emeryville, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/264,790

(22) Filed: Nov. 4, 2008

Related U.S. Application Data
(63) Continuation-in-part of application No. 12/205,107, filed on Sep. 5, 2008.
Application No. 12/205,107 is a continuation-in-part of application No. 12/242,272, filed on Sep. 30, 2008.

(51) Int. Cl. G06F 17/30

(52) U.S. Cl. 707/740; 707/E17.109; 707/E17.014

(57) ABSTRACT

A method is provided for responding to user search requests with suggested categories and attributes that have a high probability of being useful to the user for refining the search. The method is described in the context of a shared search engine platform in which multiple vertical domain repositories reside. The common search engine can search all of the repositories in a single search. The multiple vertical domain repositories can be heterogeneous in type, size, and semantics. Choosing search hints in the face of such diversity of content can be a challenge. The approach uses a “relative density” measure to determine which categories and attributes to recommend and overcomes the problem of repositories with more content dominating the chosen search terms that are returned to the user.

### PRIORITY CLAIM AND CROSS REFERENCE TO RELATED APPLICATIONS

The present claims priority as a continuation-in-part of U.S. patent application Ser. No. 12/205,107 filed on Sep. 5, 2008, entitled “Performing Large Scale Structured Search Allowing Partial Schema Changes without System Downtime,” the entire contents of which are incorporated herein by reference. It also claims priority to U.S. patent application Ser. No. 12/242,272 filed on Sep. 30, 2008 entitled “Self-Contained Multi-Dimensional Traffic Data Reporting and Analysis in a Large Scale Search Hosting System,” the entire contents of which are incorporated herein by reference.

### FIELD OF THE INVENTION

The present invention relates to search engines, and in particular to determining suggested categories and attributes for search refinement using a relative density measure.

### BACKGROUND

A search domain is a self-contained set of information pages, usually specific to a subject or function. Frequently, web sites that provide searching functionality are directed to a specific search domain. For examples, a web site for shopping may allow searching in the “product” domain, a web site for downloading music may allow searching in the “music” domain, a web site focused on medical information may allow users to look up medical information, and a financial web site may allow users to search for products or services relating to managing finances. Typically, at each of these sites, the information pages, together with structure and indexing information, are stored in a data repository.

Search engines may be used to index a large amount of information. Web sites that include search engines typically provide an interface that can be used to search the indexed information by entering certain words or phrases (keywords) to be queried. The information indexed by a search engine may be referred to as information pages, content, or documents. These terms are often used interchangeably.

A searchable item is a logical representation of an information page or piece of content that is maintained within a search engine platform. Search engines help users to locate searchable items. Sometimes a searchable item represents an electronic document, such as a white paper, or content, such as a video that can be viewed by streaming it over a network connection or downloaded to a computer system for local viewing. Other times, the searchable item is a description and representation of something in the real, physical world, such as a person, or a product for sale. Searchable items can be descriptions of electronic or physical items.

Search engines may analyze the searchable items within a repository, extracting categorization information and constructing indexes that are used to find relevant data when a search is requested. Using a search engine, a user can enter one or more search query terms and obtain a list of search results that contain or are associated with subject matter that matches those search query terms. When a user performs a search, the set of pages found during the search and presented to the user along with other search and navigation hints are called the “search results.” Each page listed in the search results is called a “hit.” When a user selects a content page for viewing, that event is called a “click” because usually, though not always, the selection is specified by clicking a mouse button.

One example of a search engine is a vertical domain search engine. A vertical domain search engine provides searching over a specific search domain. Examples of vertical domain databases include databases for searching for legal or a medical information. Within each of these examples, the content searched for has a common subject (law or medicine, respectively) and is assigned categories and attributes relevant to the subject matter by domain experts who manage the content. For example, categories supported by a law search engine might include State or Federal Case Law, State or Federal Statutes, Treatises, Legal Dictionaries, Form books, etc. with attributes such as publication date, legal topic, history, etc. A medical search engine might have categories of Symptoms, Diagnostic procedures, Treatments, and Drugs. Attributes of the searchable items in the medical search engine might include parts of the body affected and have potential values such as respiratory, circulatory, nervous system, etc. The repository for both vertical domains is highly structured within each system, but the structure for each domain is different from the structure of domains pertaining to different subject matter.

A problem faced by companies that own and operate vertical domain search engines is that, in addition to having to manage the structure of the repository, the companies must also manage the search engine platform including database management. Domain experts are not necessarily experts in IT management which can be very complex. To avoid the need for each company to maintain its own vertical search engine, multiple companies may try to combine their search engines. For example, combining a legal search engine with a medical search engine may be attempted, so that a user searching for information on medical malpractice would find content from both with one search request.

Hosting vertical domain content within the same search engine platform presents challenges to the operator of the platform resulting from the heterogeneity of the searchable content, in terms of type, size, and semantics. A common feature provided by a search engine is to return, along with the search results of a query, other related search terms for the user to try when refining the search. The ability to select helpful related terms for the user can be difficult because of the heterogeneity of the content over which the user is searching. Query terms can have different meanings in different contexts: The search results for a particular query from one vertical domain might have no relevance to search results for the same query from another vertical domain. For example, if a user searches for the keyword “plane,” the results from a travel-related vertical domain will return content regarding airplanes whereas results from a home-improvement shopping vertical domain will return content regarding a tool that shaves wood. Determining the semantics that the user had in mind (or at least the relative probability of each different interpretation) is essential for offering useful search hints. The search query itself offers no semantic information.

There are a variety of techniques to help users refine their searches. One technique is to help users focus their search after they perform an initial search. For example, the user makes an initial search based on an initial set of search terms. Then, a historical record of queries that have been issued in the past, also called a query log, is analyzed to find terms that are related to the initial search terms. Each entry in a query log records a single query. To obtain a set of related terms, a set of query log entries is found using one of the set of initial query terms, and other terms used in those queries are extracted. The terms thus extracted are referred to as a “candidate list”. Once a candidate list of related search terms is collected, each candidate term is evaluated based on how frequently the term has appeared with one of the initial query terms in prior searches.

This approach might work well when user interest is evenly distributed across vertical domains sharing the same search engine platform. However, if some repositories are generally more popular, this approach will favor returning search results relevant to more popular domains, independent of what the current user is searching for. For example, suppose a heterogeneous search engine supports two repositories “federal government” and “local.” The local repository contains information that is relevant to the local area including locations of businesses, local government organizations, chamber of commerce, maps, etc. The local repository is relatively small compared to the federal government repository, which covers all aspects of the federal government. If a user searches for “schools,” the search results from the local repository are related to the local elementary, middle, high schools, and colleges. Related search terms would be those used by others in the local community to find local schools. A federal government repository would return search results within the Dept. of Education, where people nationwide had searched for information, for example, on guaranteed student loans, “No Child Left Behind,” and “Individuals with Disabilities Education Act.” Terms related to the popular searches for these subjects would be issued far more frequently because of the larger population of people searching a federal government repository. Thus, the search terms relevant to the federal government would also be selected as more relevant using this approach, even if the user were really interested in knowing where to register their child for Kindergarten.

Another technique for determining related search terms is a variation of the technique described above. Candidate related query terms are found by analyzing the query log as described above. However, selecting which of these candidate terms to return to the user is based on how frequently each term appears in the search results produced in response to the initial query. Some number of the highest frequency candidate terms are displayed to the user. The search terms most closely related to the search results are selected for presentation to the user. Because the query log is used to derive the candidate list of relevant search terms, this technique also tends to return search suggestions that are more relevant to heavily searched repositories. There is another problem, however, based on the fact that the number of search results influences the selection of candidate suggestion terms to return. Although this approach might work well for an isolated vertical domain, when the search engine platform supports searching across multiple vertical domains, search suggestions relevant to repositories having more hits tend to be returned. Repositories having more searchable items are more likely to have more hits, and thus the set of search suggestions returned to the user are likely to be more relevant to larger repositories.

Yet another variant technique for helping users refine their searches is to create a list of the categories to which the search results belong. The categories in this list are ranked by the number of initial query search results that belong to the category. A configurable number of the top-ranked categories are then displayed to the user as suggestions for further searching. The system maintains metadata for the searchable items, and the metadata for an item indicates, among other things, the category or categories to which the item belongs. As a result, the category list can be constructed independent of the terms used in the initial search query and independent of query history. This technique is not biased by the relative search traffic in one vertical repository versus another. However, as described above, a technique that ranks suggestions based on the number of hits resulting from the initial query is more likely to select categories that are found in repositories having more searchable items.

For example, assume that one repository has categories with 10 items each, and another repository has categories with 10000 items each. Under these circumstances, it is unlikely that any of the 10-item categories will ever be suggested to a user, because the 10000-item categories will typically have more hits simply due to the vastly-larger number of items that belong to them. Thus, the categories relevant to a vertical domain with a larger repository are likely to be selected over the categories relevant to a smaller vertical domain because the probability is greater of having a hit in a larger repository.

A new approach is needed for providing search suggestions to users when the content being searched pertains to very different subjects, there is a wide variation in the amount of content for each subject, and/or the amount of user interest across content subject areas is non-uniform.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements.

FIG. 1 is a flow diagram showing the steps of enabling a search engine environment to find searchable items from a repository.

FIG. 2 is a diagram showing a logical graph structure where the nodes of the graph represent categories specific to a domain.

FIG. 3 is a diagram showing a logical view of node in the hierarchy.

FIG. 4 is a flow diagram showing the steps for counting the number of search results assigned to a node in the hierarchy.

FIG. 5 is a diagram showing an example hierarchy and calculation of relative density for each node in the hierarchy.

FIG. 6 is a flow diagram showing the steps for one embodiment for selecting categories and attributes to display as further search hints.

FIG. 7 is a diagram showing an example set of search results for calculating category and attribute relative densities.

FIG. 8 is a block diagram that illustrates a computer system.

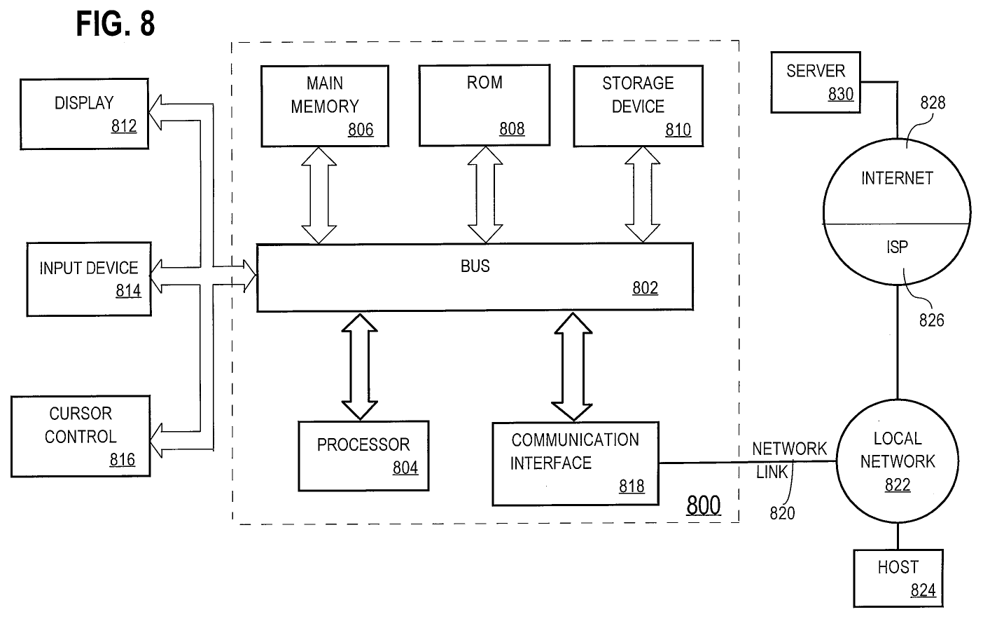

### DETAILED DESCRIPTION

An approach is described for helping users refine their searches. In one embodiment, search refinement is facilitated by returning, with the search results, (a) categories and/or (b) attribute values to use in subsequent searches. The approach, called “relative density,” determines which categories and/or attribute values to suggest based on a ratio of the number of “hits” within a category relative to the number of searchable items in the category. Similarly, attribute values are ranked according to how often a particular attribute name/value is associated with searchable items returned with the initial query result set.

In the context of a search engine hosting platform, there are two challenges that must be addressed to meet the needs of these users. The first challenge is how to determine which categories and attributes are most relevant across different content repositories having different taxonomies. The second challenge is how to avoid having the suggested related search terms always selected from a particular vertical domain for no other reason than because the domain is larger, is more heavily used, and/or contains more content than other relevant domains.

Within a hosting search engine environment, providing users with search hints can include not only specific categories and attributes within a repository to search for, but also can recommend repositories in which the user is most likely to find the content that is sought. For example, some categories, such as restaurants, schools, or gas stations are usually looked for in conjunction with their location. Thus, if a user searches for a “restaurant,” a repository of local restaurant data is more likely to provide satisfying search results than a repository with information about becoming a restaurant franchise owner.

In the following description, for purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention. Various aspects of the invention are described hereinafter in the following sections.

Representing Vertical Search Repositories in a Node Hierarchy

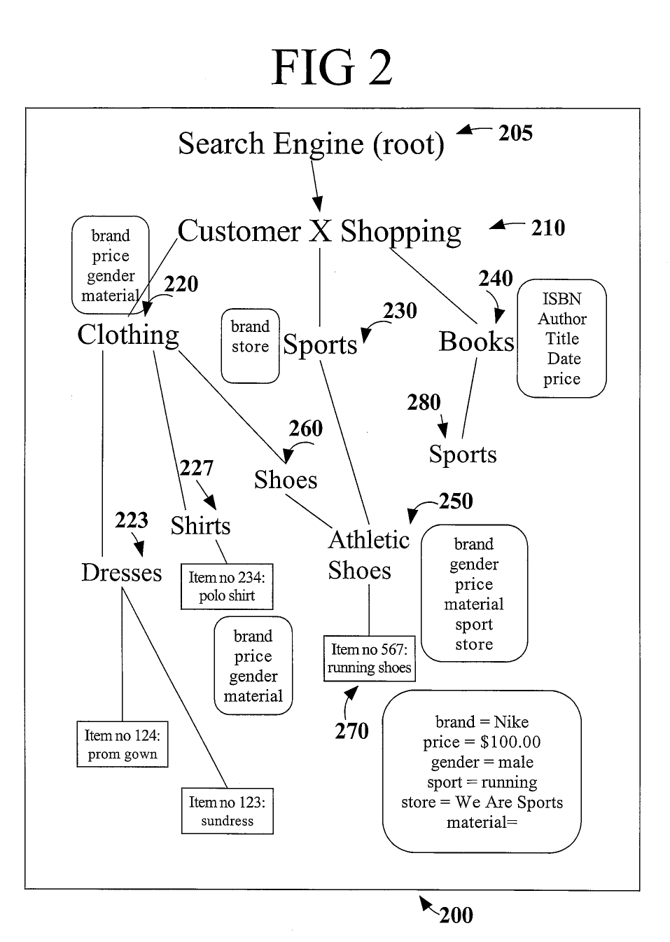

A search engine platform is used for searching over multiple vertical domain repositories whose content is heterogeneous in structure and semantics. In one embodiment, the vertical search repositories are represented as subgraphs within a node hierarchy. According to this embodiment, building such a heterogeneous search engine involves constructing a hierarchy that is a directed graph of nodes similar to a tree. The nodes of the hierarchy represent elements of the logical search repositories that are hosted by the platform. One embodiment of such a hierarchy is illustrated in FIG. 2.

Referring to FIG. 2, the root of the hierarchy represents the global search engine, and has no parents. Multiple repositories can be represented in the overall search space, each repository represented by a subgraph of the overall hierarchical structure. In one embodiment, each node other than the root represents a category, and is therefore referred to herein as a category node. Category nodes within a vertical search space represent classifications of the search items. For example, a category node of clothing might have children category nodes including dresses, pants, skirts, etc. Category nodes towards the top of a tree are more general than their children category nodes which provide refinement.

The terminology used to describe the relationships of nodes is the same as for general hierarchies. If node 1 is a descendent of node 2, then there is a path following links between the root and node 1 that contains node 2. If node 1 is a descendant of node 2, then node 1 is said to descend from node 2. Nodes may be the root of a subgraph which includes the node and all of its descendents.

Unlike a tree, nodes in the directed graph may have more than one parent node. Thus, one category node may descend from other category nodes that have no direct relationship with each other. For example, a category that represents athletic shoes may descend from both a “Shoe” category and a “Sports” category.

### Attributes

According to one embodiment, each category has associated attributes that are relevant to that category. For example, attributes relevant to clothing might include, for example, size, gender, price, and color. The attributes of a category node are inherited by their children nodes. Thus, in the example, because a shirt is a kind of clothing, all the attributes of the clothing category (e.g. size, gender, price, and color) apply to the shirt category. All searchable items have all the attributes of the category node to which the searchable items are attached (which, as explained above, includes all of the attributes of ancestor nodes of that category node). An attribute, together with the value of the attribute, is called an attribute/value pair. Thus, any given searchable item may be associated with multiple attribute/value pairs. For example, a particular shirt may be associated with the attribute/value pairs: (size, 14), (gender, male), (price, $20), (color, red), etc.

### Searchable Item Records

According to one embodiment, each searchable item of a vertical search repository is represented by a searchable item record. The searchable item record for a particular searchable item is directly assigned or linked to one category node. The searchable item belongs to the same node and also belongs to all categories that are ancestors of the category node to which the searchable item is directly assigned. For example, the searchable item record for a particular jacket may be assigned to the node that represents the Jackets and Coats category and also belongs to the Clothing category.

All searchable item records of the subgraph rooted at the Dresses category node represent searchable items related to Dresses in some way, depending on the vertical domain subject matter. For a shopping domain, searchable items belonging to the category Shirts probably represent a piece of clothing for sale. Within a theatrical domain, searchable items belonging to category Shirts might represent information on costume design.

As another example, for a searchable item that is directly assigned to the category node Athletic Shoes having parent nodes Shoes and Sports, the searchable item not only belongs to the category Athletic Shoes, but also to categories Shoes, Sports, and all ancestor categories of Shoes and Sports.

In an alternative embodiment, a searchable item is only considered to belong to the categories to which it is directly assigned. For example, in this embodiment, a searchable item representing a kind of athletic shoe for sale may only belong to the Athletic Shoes category, and not belong to the Shoes, Sports, or any other ancestor categories.

In yet another alternative embodiment, a searchable item may be assigned or linked directly to multiple category nodes.

In addition, searchable items contain a set of attribute name/value pairs. The hierarchy supports many different types of searchable items, including but not limited to, electronic content such as text documents, web pages, or electronic media as well as items in the real, physical world, such as a person, or a product for sale. Different types of searchable items have different sets of associated attributes.

### Inheriting Attributes

Nodes may have multiple parents. Thus, a Sports Apparel category node may be the child of both a Sports category node and a Clothing category node. A node with multiple parents inherits the union of the parents' attributes. For example, the Clothing category might have attributes brand, price, gender, material, and the Sports category might have attributes brand and store. Brand may be an attribute of both Clothing and Sports, and would show up as one attribute in the union of {brand, price, gender, material, and store}. Searchable item records can store values for each of the attributes associated with the category node to which they are linked. However, not every potential attribute must have a value specified. A tennis dress for sale might not specify the kind of material, for example.

### Obtaining Content for a Vertical Domain Repository

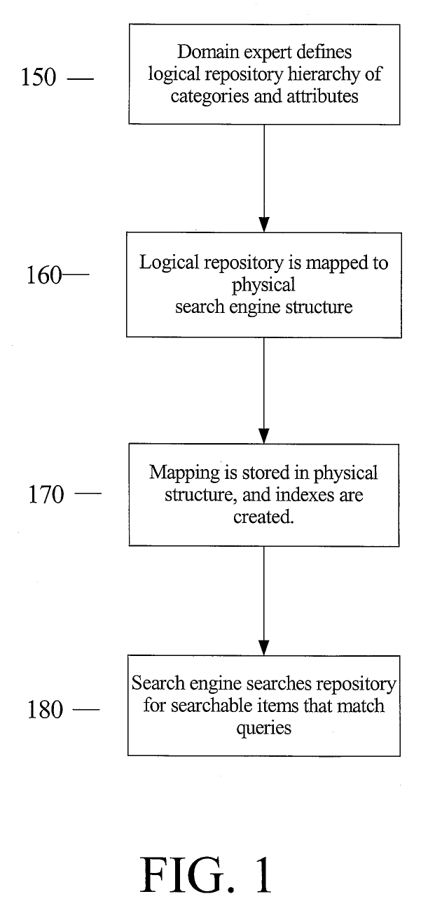

FIG. 1 shows the process for getting content from a vertical domain to be searchable on a shared search engine platform. In the embodiment illustrated in FIG. 1, domain experts define the logical hierarchy of categories and attributes that represent their repository and how the repository can be searched (Step 150). A domain expert can interact with an Integrated Development Environment (IDE) 120 that provides a graphical user interface (GUI) or alternatively, a domain expert may upload a definition of the hierarchy constructed in some other way. The domain expert defines a logical hierarchy comprising of categories, logical attributes, and the relationships among them. For example, transportation->cars->convertibles->classic cars might be one category hierarchy that a domain expert would choose. Hobbies->classic cars->convertibles might be another. The way in which the category hierarchy is defined determines how users can browse through the content. Logical attributes are a type of information associated with a category that is common across a subset of a category hierarchy. For example, model year might be an attribute of cars, convertibles, and classic cars, but not of transportation or hobbies.

Once the domain expert is finished defining the category hierarchy, the hosting service is responsible for translating the logical description of the content structure into the physical structure of the shared search engine hosting platform that can be accessed by the search engine (Steps 160, 170). A mapping from the logical description to the physical storage is computed (Step 160), then the mapping and the computed indexes are stored in the physical structure (Step 170). Once loaded into the physical hosting platform, a user can interact with the search engine to find desired content (Step 180).

### Defining the Hierarchy

FIG. 2 shows an example of the logical representation of a customer's searchable content 200. In this example, the customer's searchable content is products for sale. The root of the hierarchy is the virtual search engine node 205. The root node is virtual because this node is not indexed. The root is a parent of all of the top level subgraphs, each of which can represent a distinct repository. There are three rules imposed on the logical hierarchical structure. First, there no cycles allowed in the graph. Thus, a node cannot both descend from, and be an ancestor of, the same other node.

Second, there is a single configurable limit on the number of attributes that are associated with any given node, and that number must not exceed the number of physical attributes that are indexed by the platform. For example, assume that the platform indexes 20 physical attributes. If a particular category node is associated with 15 attributes, then category nodes that descend from that particular category node may define, at most, five additional attributes. The limit on the total number of attributes that can be associated with any given node ensures that for every node, there is a mapping for each logical attribute of the node to a different physical attribute of the platform.

In the example illustrated in FIG. 2, Customer X Shopping 210 is the top-level node of the subgraph representing a content repository. Directly under the top-level node 210, are the top-level categories, Clothing 220, Sports 230, and Books 240.

The rounded rectangles next to some of the nodes shown in FIG. 2 contain example attributes associated with the node. The attributes associated with Clothing 220 include brand, price, gender, and material. All nodes in the subgraph rooted at Clothing 220 will have at least this set of attributes, and therefore, all searchable items of Clothing will contain at least these attributes. The category Sports 230 has attributes brand and store. Brand means the same thing with respect to sports as it means to with respect to clothing. Consequently, the brand attribute of Clothing is “semantically identical” to the brand attribute of Sports. Category Books 240, on the other hand, has no attributes in common with Sports 230, either in name or in meaning. Thus, all of its attributes are “semantically different” or distinct from the attributes of Sports 230.

Athletic Shoes 250 is a child node of both Sports 230 and Shoes 260, and must inherit all the attributes of both parents. Athletic Shoes 250 inherits attributes brand and store from its Sports 230 parent and brand, price, gender, and material from its Shoes 260 parent (which were inherited from Clothing 220). In addition, a sport attribute is directly assigned to the Athletic Shoes 250 category node.

The searchable item records of the hierarchy are the searchable items, which in this example are the product descriptions. The searchable item representing Item no 567 (270) is a particular kind of running shoe for sale, and that searchable item is linked to Athletic Shoes 250. Thus, the searchable item 270 may define values for all of the attributes associated with Athletic Shoes 250. Searchable item 270 has attribute values specified for most of the attributes. In this example, Item no. 567 (270) is a men's Nike brand running shoe that sells for $100 at the We Are Sports store.

### Logical Structure of a Node

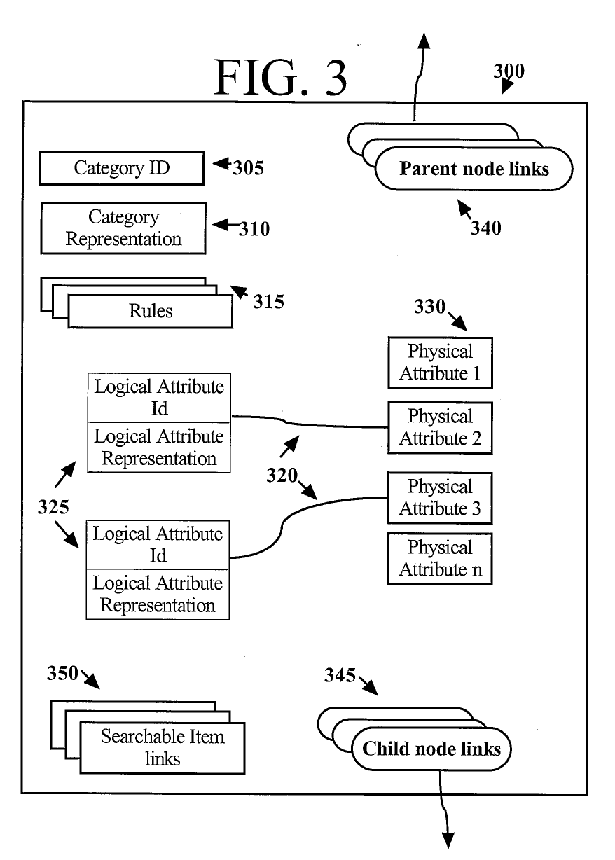

FIG. 3 shows a logical view of one embodiment of a category node 300. Node 300 contains Parent Links 340 and Children Links 345 that together represent the node's position in the hierarchy. The Category Id 305, also called a “node id” provides unique identification of the node in the hierarchy. A node also contains links to the Searchable Items 350 that link the node to the set of searchable items assigned directly to the category.

The Category Representation 310 is a way of identifying the category to a user. Category Representation 310 might be an icon or text, for example. In FIG. 2, the textual name “Athletic Shoes” is the category representation of node 300. Two different category nodes (different id's) could have the same Category Representation 310, but the categories would be considered different categories. For example, in FIG. 2, Books 240 has a child category node Sports 280 representing books about sports. Nodes 230 and 280 both have the same category representation: the textual name “Sports”, but 230 and 280 are different nodes and thus are different categories.

A node has a set of rules 315 that define category policy. Some example rules are: the sorting method to be used for the values of an attribute, how many and which attributes should be listed in the navigation panel before a “see more” link is shown to see the rest, and how many search results (aka searchable items) should be displayed per page in response to a query performed in the context of the node.

A node has a set of Logical Attribute Id's 325 that are relevant to the category of the node. Preferably, each logical attribute id in the system has a distinct semantic meaning. A logical attribute id has associated with it a representation for the user, called the Logical Attribute Representation. Even if different logical attribute id's were to have the same user representation, the logical attributes would be considered semantically different from each other. Conversely, different nodes that have the same associated attribute id's may use a different user representation for the same attribute id. For example, “price” may be the user representation for a logical attribute associated with one category, and “cost” may be the user representation for that same logical attribute in a different category.

There are many ways that this logical representation of a node can be stored physically. One way is to store the node as a set of tables in a relational database. Another way is to represent each node as an in memory object. Still another way is to store the node information in an XML document.

### Searching Across Vertical Domains

When a global search is performed, search results may be returned from more than one vertical domain. For example, searching for “vacations” might return hits from several different travel repositories. In this case, vacations means the same in each of the repositories, and all the results returned are relevant to the user's intention of finding relaxing travel destinations. However, sometimes the semantics of different vertical domains is quite different, and the interpretation of a search term can be quite different. For example, if a legal information repository shared the same search engine platform with a shopping domain and the user searched for “briefs,” search results might include both summaries and analysis of court opinions as well as men's underwear for sale.

### Counting Hits in a Subgraph

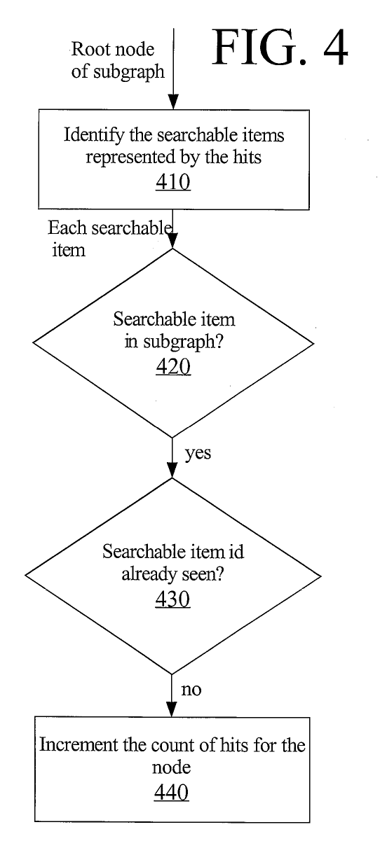

Each searchable item has a unique identifier associated with it. A searchable item that satisfies the search query is referred to as a “hit.” Counting the hits associated with a node is done by counting the number of hits residing in the subgraph rooted at the node, as shown in FIG. 4.

Referring to FIG. 4, it illustrates four steps to counting hits within a subgraph, according to an embodiment of the invention. The steps involve successive filtering, and include: identify which searchable items satisfy the query (ie. the set of searchable items that are hits) (Step 410), of this set, identify and only consider which searchable items reside within the subgraph (Step 420), remove duplicate searchable items, if necessary, based on their unique identifiers (Step 430), and increment the count for searchable items that have not been eliminated through the previous steps (Step 440). In a subgraph that has at least one node with multiple parents, there will be searchable items with more than one path from the root of the subgraph to the node associated with the searchable item. Thus, when a searchable item belongs to more than one category, more than one instance of the searchable item might be found during the search, each corresponding to a different path. However, the search engine filters duplicate instances before returning search results, and only the unique search results within the subgraph are counted as hits.

### Suggesting Categories for Search Refinement

A simple approach to selecting the best categories to return to the user as search hints would be to simply count the hits associated with each category node, and return with the search results, an indication of the categories associated with the nodes having the most hits. This approach would work if the subgraphs had an equal number of searchable items, but favors subgraphs with more searchable items when the search hierarchy is unbalanced.

To overcome the problem of an unbalanced search space, techniques are described hereafter for selecting categories based on a relative density measurement for each node in the hierarchy. The relative density measure reflects a normalized count of hits. The number of hits within a subgraph is the number of searchable items returned in the search results that are contained in that subgraph. To normalize the hits within the subgraph, the number of hits is divided by some measure of the size of the subgraph.

### Calculating Relative Density for Categories

Relative density is a relevancy measure that normalizes for the size of all the subgraphs over which the search takes place. Different embodiments employ different calculations as described below.

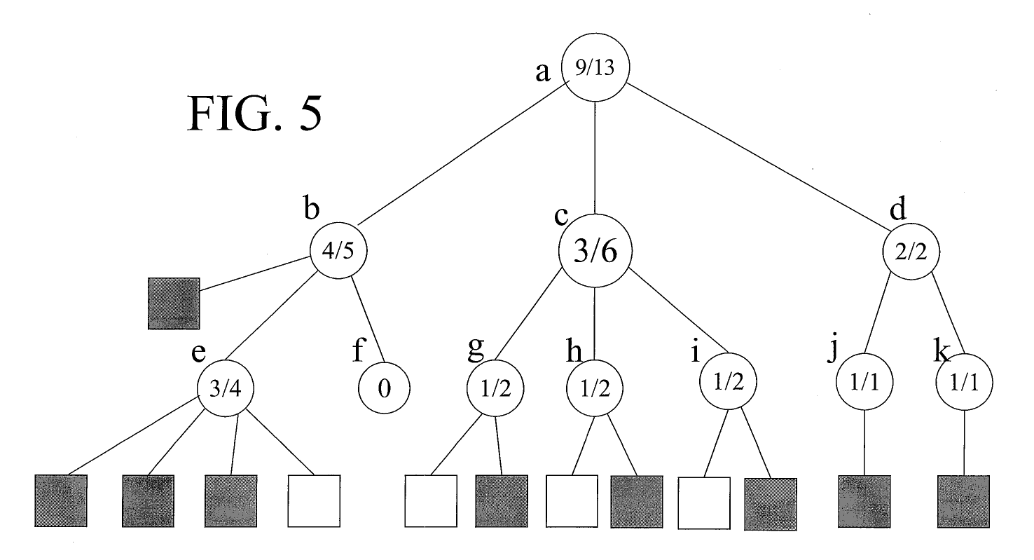

FIG. 5. shows a simple example for calculating the relative density, where the size of each subgraph is measured by the number of searchable items contained within it. In this embodiment, relative density is computed by dividing the number of hits in the subgraph rooted at the node by the number of searchable items in the subgraph rooted at the node. In the example shown in FIG. 5, the category nodes of the hierarchy are represented by circles and labeled with letters, and the searchable items linked to those category nodes are represented by squares and are not labeled. Root node a defines a subgraph containing thirteen searchable items. Nine of searchable items in the figure are shaded to indicate that the searchable items were hits for a query. The relative density for each node of the subgraph appears inside the node. For the root a, the relative density is nine hits divided by thirteen searchable items (9/13), and nodes b, c, d, e, f g, h, i, j, and k have relative densities of 4/5, 3/6, 2/2, 3/4, 0, 1/2, 1/2, 1/2, 1/1, and 1/1 respectively. The hierarchical structure supports searching within a subgraph of the hierarchy. When performing such a search, relative densities are computed only for the nodes in the subgraph being searched. It would not make sense to recommend a category for further exploration that is outside of the initial search boundaries.

In other embodiment, the size of the subgraph is measured as the total number of nodes in the subgraph and the relative density is the number of hits over the number of nodes in the subgraph. In the subgraph of FIG. 5, the subgraph has eleven nodes, so the relative density for root nodes a through k would be 9/11, 4/3, 3/4, 2/3, 3/1, 0, 1/1, 1/1, 1/1, 1/1, 1/1 respectively.

The ultimate goal of the relative density function is to derive a score for each node that is proportional to the density value at the node, the density of hits within the vertical search repository, and the density of the total number of hits in a category. A more sophisticated and complex embodiment attempts to achieve these goals by calculating the relative density for a category node employing the following information:
cat_hits=number of hits in the subgraph rooted at the node, the total number of searchable items in the subgraph rooted at the node
agg_cat_size=the total number of searchable items in the subgraph rooted at the node
native_cat_size=the number of searchable items directly assigned to the node
graph_size=the number of searchable items stored within the entire search engine
sub_graph_size=the number of searchable items in the entire vertical repository
   The relative density for each node is then computed as:

category_relative_density=(cat_hits/agg_cat_size)*log(cat_hits)*log(native_cat_size)*(1−sub_graph_size/graph_size)

### Calculating Relative Density for Attribute Values

In addition to calculating relative density for categories, relative density scores may be calculated for attribute values as well. Attribute value relative density is computed in the context of a particular category node. One example of a scoring function for calculating relative density for attribute values uses:
attr_val_hits=number of hits representing searchable items within the subgraph rooted at the category node and containing a specific attribute value (e.g. color=blue)
total_attr_val_size=total number of searchable items having a specific attribute value and found in the subgraph rooted at the category node (not necessarily hits for the search)
   The relative density is computed as:

attribute_relative_density=(attr_val_hits/total_attr_val_size)*log(attr_val_hits)

For example, if there are a total of 20 searchable items in the subgraph having the attribute name/value pair color=blue, but only 10 of them show up as hits because the search query further requires “gender=female,” then the attribute value score would be:

(10/20)*log(10)=0.5

### Selecting Categories to Suggest Based on Relative Density

When selecting a subset of categories to suggest as hints for additional searches or navigation, the nodes representing the categories may be ordered as a function of their relative density. Continuing the simple example of FIG. 5, the category nodes may be ordered based only on their relative density, independent of their level in the hierarchy or relative densities of attribute name/value pairs. According to the example where relative densities are determined based on the number of hits and the total number of searchable items in the subgraphs, the nodes in FIG. 5 would be ordered as follows: {(d, j, k), a, b, e, (c, g, h, i), f}. The nodes in parentheses all have the same relative density value. In one embodiment, nodes with the same relative density value have equal ranking. Thus, if only one node were to be selected to return as a suggestion for further searching, any one of d, j, or k could be returned. However, some nodes having the same relative density have different numbers of searchable items in their subgraph. In another embodiment, the ordering of category nodes also considers the number of searchable items in each node's subgraph. For example, node d has a ratio of 2/2 and node j has a ratio of 1/1. Nodes d and j have the same relative density, but there are more searchable items in node d's subgraph. When considering the number of searchable items in a subgraph, node d would be ranked higher in the ordering than node j. Using that policy, the ordering of nodes in FIG. 5 would be: {d, (j, k), b, e, a, c, (g, h, i), f}. Other embodiments may apply other heuristics along with the relative density to determine the ordering among category nodes.

The embodiment described earlier, that employs more complex computations, uses the size of the subgraph in the computation of the relative density itself, and not only used only to determine the order among categories having the same relative density computed in a simpler way.

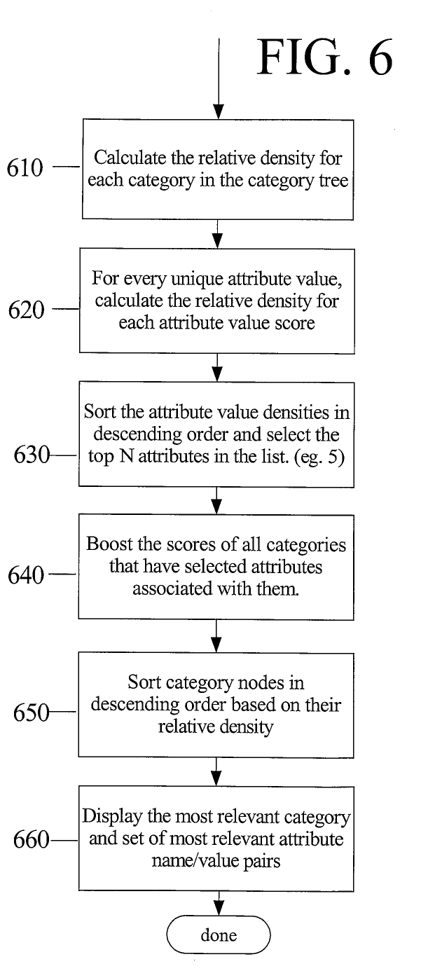

FIG. 6 is a flow diagram for a different embodiment that considers the relative density of attribute name/value pairs when determining which categories to return to the user along with search results. In Step 610, the relative density for each category is computed. In Step 620, the relative density for each unique attribute name/value pair is computed. The resulting attribute relative densities are used to sort the attribute name/value pairs in descending order where the attribute name/value pairs with the highest densities are the most relevant to the user's search. Some configured number (N) of attributes is selected from the top of the list. (Step 630). Of the top N selected attribute names, find the categories that have searchable items belonging to the category containing those attribute name/value pairs, and boost the relative density scores of those categories (Step 640). Because attribute name/value pairs are ranked, the same attribute name might appear in the top N attribute relative densities more than once. For example, if both “color=red” and “color=blue” were to appear in the top N attribute relative density list, those categories containing some searchable items with “color=red” as well as other searchable items with “color=blue” would have their category relative density scores boosted twice.

One example of boosting the relative density score is:

$$new\_category \_relative \_density = category\_relative \_density + {\sum }_{i = 1}^{5} {C}_{i} * attribute\_value \_relative {\_density}_{i} .$$

In Step 650, the category nodes are sorted in descending order according to their (potentially new) relative densities, and the most relevant category along with the most relevant attribute name/value pairs are returned to the user as search suggestions (Step 660).

### Example of Calculating Relative Density for a Complex Embodiment

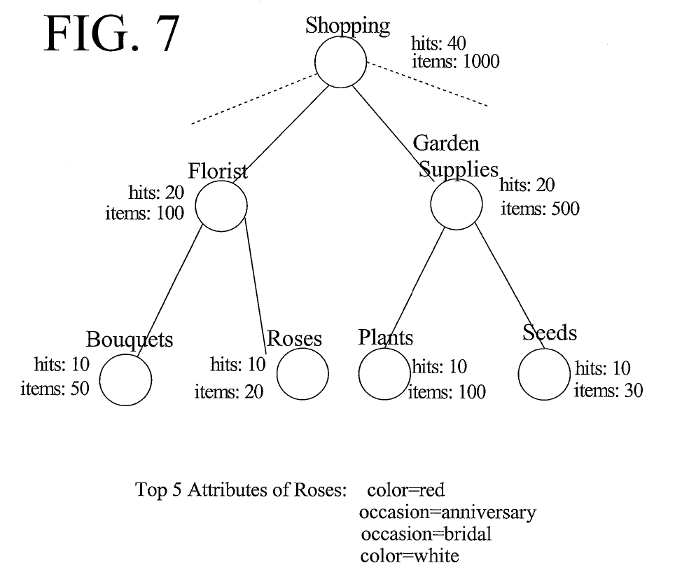

FIG. 7 shows an example of results in response to a search result for “flowers” in a vertical shopping repository. The Shopping node represents the root of the vertical repository, and the dotted lines connecting to it represents other category nodes in the hierarchy not shown in the example. Searchable items matching the search for flowers were found within two vendors: a florist and a garden supply store. The florist provides cut flowers and the garden supply store provides seeds and plants for the garden. The attribute value specified in the search was price<$50.00.

The Florist and Garden Supply category nodes have no searchable items directly assigned to them. The searchable items found within the Florist subgraph were found attached to category nodes “Bouquets” and “Roses.” There are 50 searchable items in the Bouquets category of which 10 matched the query (i.e. were hits). There are 20 searchable items attached to the Roses category, of which 10 were hits. Not all of the searchable items in these categories were hits because some bouquets and roses cost more than $50.00. In the Garden Supplies subgraph, the Plants category node has 100 searchable items directly attached of which 10 were hits, and the Seeds category node has 30 searchable items directly attached of which 10 were hits. The Shopping vertical repository has 1000 searchable items in the hierarchy, of which 40 were hits (add together the hits enumerated above: 10+10+10+10).

The complex formulas specified above are used to compute the relative density of each node. We assume that the entire search engine has 2000 searchable items, and the vertical shopping repository has 1000 items, so the term (1−sub_graph_size/graph_size) will evaluate to (1−1000/2000) or 0.5 for all the calculations. The relative density of the nodes is calculated as:

| | |
|---|---|
| Plants | $\frac{10}{100} * log ( 10 ) * log ( 100 ) * ( .5 ) = .1 * 1 * 2 * .5 = .1$ |
| Seeds | $\frac{10}{30} * log ( 10 ) * log ( 30 ) * ( .5 ) = .33 * 1 * 1.48 * .5 = .24$ |
| Bouquets | $\frac{10}{50} * log ( 10 ) * log ( 50 ) * ( .5 ) = .2 * 1 * 1.7 * .5 = .17$ |
| Roses | $\frac{10}{20} * log ( 10 ) * log ( 20 ) * ( .5 ) = .5 * 1 * 1.3 * .5 = .33$ |
| Garden Supplies | $\frac{20}{500} * log ( 20 ) * log ( 500 ) * ( .5 ) = .04 * 1.3 * 2.7 * .5 = .07$ |
| Florist | $\frac{20}{100} * log ( 20 ) * log ( 100 ) * ( .5 ) = .2 * 1.3 * 2 * .5 = .26$ |
| Shopping | $\frac{40}{1000} * log ( 40 ) * log ( 1000 ) * ( .5 ) = .04 * 1.6 * 3 * .5 = .1$ |

Based on the relative densities calculated for the category nodes, Roses has the highest relative density with 0.33. Thus the attribute name/value relative densities are calculated in the context of the Roses category node. If the attribute color with value red is found in 10 of the searchable items attached to the Roses category, but only 5 of the 10 hits have the attribute value color=red (red roses tend to be expensive, and not all searchable items with red roses are under $50.00). Thus, the attribute value relative density for color=red is:

$$\frac{5}{10} * log ( 5 ) = .5 * .7 = .35 .$$

### Hardware Overview

FIG. 7 is a block diagram that illustrates a computer system 800 upon which an embodiment of the invention may be implemented. Computer system 800 includes a bus 802 or other communication mechanism for communicating information, and a processor 804 coupled with bus 802 for processing information. Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Computer system 800 further includes a read only memory (ROM) 808 or other static storage device coupled to bus 802 for storing static information and instructions for processor 804. A storage device 810, such as a magnetic disk or optical disk, is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

The invention is related to the use of computer system 800 for implementing the techniques described herein. According to one embodiment of the invention, those techniques are performed by computer system 800 in response to processor 804 executing one or more sequences of one or more instructions contained in main memory 806. Such instructions may be read into main memory 806 from another machine-readable medium, such as storage device 810. Execution of the sequences of instructions contained in main memory 806 causes processor 804 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 800, various machine-readable media are involved, for example, in providing instructions to processor 804 for execution. Such a medium may take many forms, including but not limited to storage media and transmission media. Storage media includes both non-volatile media and volatile media. Non-volatile media includes, for example, optical or magnetic disks, such as storage device 810. Volatile media includes dynamic memory, such as main memory 806. Transmission media includes coaxial cables, copper wire and fiber optics, including the wires that comprise bus 802. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 804 for execution. For example, the instructions may initially be carried on a magnetic disk of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are exemplary forms of carrier waves transporting the information.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution. In this manner, computer system 800 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method to display search results for a search query, the method comprising the steps of:
receiving said search query for finding searchable items in one or more repositories;
wherein categories associated with said one or more repositories are represented as nodes of a hierarchy of nodes;
wherein each searchable item belongs to one category represented by the nodes in the hierarchy of nodes;
in response to receiving the search query, performing the steps of:
determining which searchable items, of the searchable items that belong to a set of categories represented by nodes in the hierarchy of nodes, satisfy the search query;
for a plurality of nodes in the set, computing a relative density based at least on
(a) the number of searchable items that both (a) satisfy the search query and (b) belong to the category represented by the node; and
(b) the total number of searchable items belonging to the category represented by the node;
selecting, from the plurality nodes, one or more nodes based on the relative density computed for the one or more nodes; and
in response to selecting the one or more nodes, returning search results that include a representation of at least one of (i) one or more categories represented by the one or more nodes, or (ii) one or more values associated with attributes of said one or more nodes.

2. The method of claim 1, wherein computing a relative density is further based on a relative density of each attribute name/value pair assigned to searchable items directly linked to the node.

3. The method of claim 1 wherein the representation is of one or more categories represented by the one or more nodes.

4. The method of claim 1 wherein the representation is of one or more values associated with attributes of said one or more nodes.

5. The method of claim 1 wherein the step of computing a relative density for a node comprises dividing the number of searchable items belonging to a category represented by the node that satisfies the search query by the number of searchable items belonging to the category represented by the node.

6. The method of claim 1 wherein the one or more repositories include a plurality of repositories.

7. The method of claim 6 wherein the plurality of repositories includes at least a first repository for a first type of searchable item and a second repository for a second type of searchable item, wherein the first type of searchable item is different than the second type of searchable item.

8. The method of claim 7, wherein computing a relative density is further based on at least one of:
(a) the number of searchable items belonging to all the nodes in the plurality of repositories or
(b) the number of searchable items belonging to the first repository, wherein the node representing the category belongs to the first repository.

9. The method of claim 3 wherein the representation includes the name of the category associated with the one or more nodes.

10. A method comprising:
receiving a search query;
determining a set of searchable items that match the search query;
for each of a plurality of categories into which said searchable items have been organized, calculating a relative density based on:
a total number of searchable items that belong to the category; and
a number of searchable items that belong to the category and match the search query;
selecting one or more categories based on the relative density calculated for the categories; and
providing a representation of the one or more categories.

11. The method of claim 10, wherein the relative density for a plurality of categories is the same, and the step of selecting one or more categories is further based on the total number of searchable items that belong to the category.

12. The method of claim 1, further comprising:
determining the total number of searchable items belonging to the category represented by the node, wherein the node is the root of a subgraph;
wherein a searchable item is directly assigned to a node having a plurality of parent nodes within the subgraph.

13. The method of claim 12, wherein each searchable item that is directly assigned to a node having a plurality of parent nodes within a subgraph is counted as a single searchable item belonging to said subgraph.

14. The method of claim 13, wherein a searchable item is associated with a unique identifier; and
the step of determining the total number of searchable items in a subgraph further comprises counting the number of distinct unique identifiers associated with searchable items within a subgraph.

15. The method of claim 1 wherein said search query is for finding searchable items in a single repository; and
the step of computing a relative density is performed only for nodes within said single repository.

16. The method of claim 15 wherein said search query is for finding searchable items in a particular subgraph of said single repository; and
the step of computing a relative density is performed only for nodes within the particular subgraph within said single repository.

17. A method to display relevant set of web search results for a user query comprising the steps of:
in response to receiving and performing a user query on a repository of searchable items represented by a hierarchy of nodes, wherein each node represents a category, retrieving a set of search results;
based on the search results, determining which categories to display to the user;
determining which attributes of said nodes to display to the user, wherein the step of determining is based on the relative density of each attribute name/value pair in the union of all attribute name/value pairs contained by searchable items in said set of search results; and
in response to selecting the one or more attribute name/value pairs, displaying to the user at least the values from the attribute name/value pairs associated with the one or more nodes to the user.
